(19) United States
(12) Patent Application Publication
(10) Pub. No.: US 2012/0198974 A1
(43) Pub. Date: Aug. 9, 2012

(54) METHOD FOR OBTAINING CONSTANT WEIGHT SLICES FROM SLICED FOOD PRODUCTS AND DEVICE FOR PERFORMING SAID METHOD

(75) Inventor: Günther Weber, Gross Nemerow (DE)

(73) Assignee: WEBER MASCHINENBAU GMBH BREIDENBACH, Breidenbach (DE)

(21) Appl. No.: 13/389,412

(22) PCT Filed: Jul. 20, 2010
(86) PCT No.: PCT/EP10/04433

§ 371 Date: Apr. 17, 2012

(30) Foreign Application Priority Data
Aug. 7, 2009 (DE) 10 2009 036 682.2

(51) Int. Cl. B26D 3/28; B26D 7/06; B26D 5/00

(52) U.S. Cl. 83/13; 83/365; 83/364

(57) ABSTRACT

The invention relates to a method of acquiring slices or portions of slices of constant weight from food products sliced by a cutting apparatus. A plurality of cross-sectional areas Fi of the product are determined for at least one product to be sliced, in particular in accordance with the light sectioning process. The total weight Gges of the product is determined; control data are calculated using the cross-sectional areas Fi and the total weight Gges; and the cutting apparatus, is operated at least in part using the control data.

The invention relates to a method of acquiring slices or portions of slices of constant weight from food products sliced by means of a cutting apparatus, in particular by means of a high performance slicer, wherein a plurality of cross-sectional areas of the product are determined for at least one product to be sliced, in particular in accordance with the light sectioning process; the total weight of the product is determined; control data are calculated using the cross-sectional areas and the total weight; and the cutting apparatus, in particular a product feed of the cutting apparatus, is operated at least in part using the control data.

The invention also relates to an apparatus for slicing food products which in particular works and/or is operated in accordance with the aforesaid method. This apparatus includes a product feed which is designed to feed at least one product to be sliced to a cutting plane in which at least one cutting blade moves, in particular in a rotating and/or revolving manner; a scanning device, in particular working in accordance with the light sectioning process, for determining a plurality of cross-sectional areas of the product; and a control and calculation device for calculating control data using the cross-sectional areas and the total weight of the product and for operating the cutting apparatus, in particular the product feed, at least in part using the control data.

The invention furthermore relates to a method and to an apparatus for determining control data which can be used for an apparatus for slicing food products, in particular for a high performance slicer.

As will be stated in more detail in the following, such cutting apparatus, also simply called slicers, are generally known. Slices are, for example, cut from food products at a constant cutting frequency using circular blades which revolve in a planetary motion and additionally rotate or using only rotating scythe-like blades which have speeds of several hundred up to some thousand revolutions per minute. In practice, it is important that either the individual slices or portions formed from a plurality of slices have a predefined weight. Since the cutting frequency is constant, the weight of the individual slices is preferably influenced in that the thickness of the slices is varied and this takes place by a corresponding control of the product feed: the further the product is advanced beyond the cutting plane between two cuts of the blade following one another, the greater the thickness of the product slice subsequently cut off. The slice thickness is only one parameter which determines the weight of the respective slice. The slice weight is determined by the slice volume and the average density of the slice, with the slice volume resulting from the slice thickness and the outer surface contour of the slice.

An apparatus is known from WO 99/06796 A1 for slicing a food product, e.g. a meat product, into individual slices of a predefinable weight (page 1, paragraph 2; page 16, lines 1-6).

In the respect, the yield of the product on the slicing should be maximized and the loss or waste should be minimized (page 1, lines 12-14).

The respective food product which has an irregular surface profile is conducted on a transport belt over a weighing station for weight determination and through a scanning device, for determining its surface profile, with the respective peripheral contour being detected transversely to the transport direction at predefinable intervals in the scanning device. The signals of the scanning device are fed to a microprocessor control unit which calculates and stores the cross-sectional area and the cross-sectional contours at the predefined intervals page 12, lines 2-18).

The volume is calculated from the stored values and the density of the food product is determined by dividing the total weight by the volume (page 15, lines 25-32).

The volume, weight, density and the three-dimensional peripheral contour of the food product are stored in a memory of the microprocessor control unit and can then be fed from the microprocessor to a processing apparatus for the food product. The stored data for each food product or for each meat product can thus, for example, be fed to a slicing apparatus so that the meat product can be sliced into slices of predefined weight, with the cutting apparatus being able to determine the thickness of each slice from the stored data to obtain slices of predefined weight (page 15, line 33, to page 16, line 6).

The scanning device for determining the peripheral contour of the respective products in this respect preferably comprises one or more ultrasound scanning heads pivotable about the product. Alternatively, the use of laser scanners or other suitable scanners is proposed (page 17, lines 10-13).

Comparable apparatus and processes are also described in WO 99/47885 A2 as well as in DE 198 20 058 A1.

A method and an apparatus are known from DE 196 04 254 A1 for acquiring portions or slices of constant weight from sliced food products of irregular shape, with the good product yield being said to be increased in slicing in the same way as in the case of WO 99/06796 A1 (page 1, lines 24 and 25).

For this purpose, the outer surface contour of the respective food product is in turn determined before the slicing and the mass of a product piece enclosed by this outer surface contour is directly calculated from the outer surface contour. The slice thickness can be set in dependence on the outer contour by a corresponding change in the advance on the slicing so that the slice masses or the slice weights of a portion differ less greatly (page 1, lines 40-42; page 1, line 67, to page 2, line 1).

In this case, a plurality of line projection lasers and a plurality of associated taking devices in the form of cameras which are arranged at a defined angle to the laser are provided in a scanning device for detecting the total outer surface contour (page 3, lines 37-41; page 4, lines 56-61). The respective camera in this respect observes the course of the projected laser line and a calculator connected to the cameras calculates the cross-sectional area of a potential product slice from the obtained signals (page 3, lines 49-54). The scanning device consequently works according to the so-called light-cutting process.

The slice thickness is varied via the control system of the slicing apparatus in dependence on the size of the respective cross-sectional area.

An automatic system is known from EP 1 178 878 B1, which goes back to WO 00/62983 A1, for processing a product on the basis of the detection of its surface profile having a conveyor belt on which the product is conducted in order between a scanning device and a product processing device, wherein the scanning device has line lasers above and beneath the product for illuminating the surface profile of the product and cameras for imaging the surface profile determined by the line lasers. In this respect, each line laser is adapted to illuminate the surface profile of the product over a plane transverse to the conveying direction of the product and a control device is connected to the cameras to determine the volume of the product by detecting and processing a plurality of visual images which are detected by the cameras along the length of the product during the passage of the product through the scanning device, wherein the control device is arranged so that it has carried out the processing of these virtual images before the product is processed in the product processing device and the product processing device has a control system to vary its processing procedures at the product in part on the basis of the volume of the product.

This system differs from the apparatus in accordance with WO 99/06796 A1 in that instead of a scanning arrangement having moving sensors which are designed for distance measurement, a scanning arrangement is used having line projection lasers or line lasers with associated cameras such as is known for the same purpose from DE 196 04 254 A1.

To the extent that the actual procedure is mentioned at all in the utilization of the determined contour data or profile data, the known apparatus share the feature that first the total volume of the product is calculated from the contour data or profile data and the average product density is calculated from this—using the likewise measured total product weight.

It is the object of the invention to improve the known systems with respect to the utilization of the contour data or profile data, in particular to minimize the technical calculation effort.

This object is satisfied by the features of the independent claims.

The invention is based on the idea of utilizing only the cross-sectional areas of the product and its total weight for the calculation of the control data in that a weight table is prepared from these variables determined directly at the product and it is then possible to work with the weight table in the slicing or in the preparation of a slicing plan.

Every form of volume calculation is superfluous in comparison with conventional processes due to the invention. Furthermore, no calculation determination of the density based on a determined volume takes place within the framework of the invention either.

The invention thus consistently avoids the calculation of such variables which are per se not needed at all to achieve the preferred aim, namely the acquisition of slices or portions of slices of constant weight. For this purpose, the knowledge of the volume of the product to be slices is namely neither necessary nor of interest. The same applies to the average density of the product. Since the invention avoids the calculation of such unnecessary intermediate parameters, an extremely efficient processing of the cross-sectional areas and of the total product weight can take place with the preferred aim of an acquisition of slices or slice portions of an exact weight.

In a further preferred embodiment, the determination of the cross-sectional areas of the product takes place in accordance with the light sectioning process. This is, however, not compulsory. Alternatively or additionally, methods based on another measurement principle can also be used to determine the cross-sectional areas of the product, since how the required cross-sectional areas are specifically determined at the product is not relevant to the subsequent calculations.

In accordance with a further advantageous embodiment, the cross-sectional areas on the basis of which, together with the total weight of the product, the weight table is prepared, are each a mean value of two cross-sectional areas measured directly following one another.

In a further preferred embodiment of the invention, the cross-sectional areas are determined perpendicular to a product feed direction, with the cross-sectional areas being determined at constant intervals along this product feed direction.

Provision can be made in the methods and apparatus in accordance with the invention that the determination of the total product weight takes place as part of the cross-sectional area determination. Scales for determining the total weight of the product can in particular be integrated into a scanning device serving for determining the cross-sectional areas. This is, however, not compulsory. The total product weight can also be determined at another point in time and can be provided in a suitable manner to the method in accordance with the invention or to the apparatus in accordance with the invention such that it can be taken into account in the preparation of the weight table.

Further preferred embodiments of the invention are also set forth in the dependent claims, in the description and in the drawing.

The invention will be described in the following by way of example with reference to the drawing. There are shown:

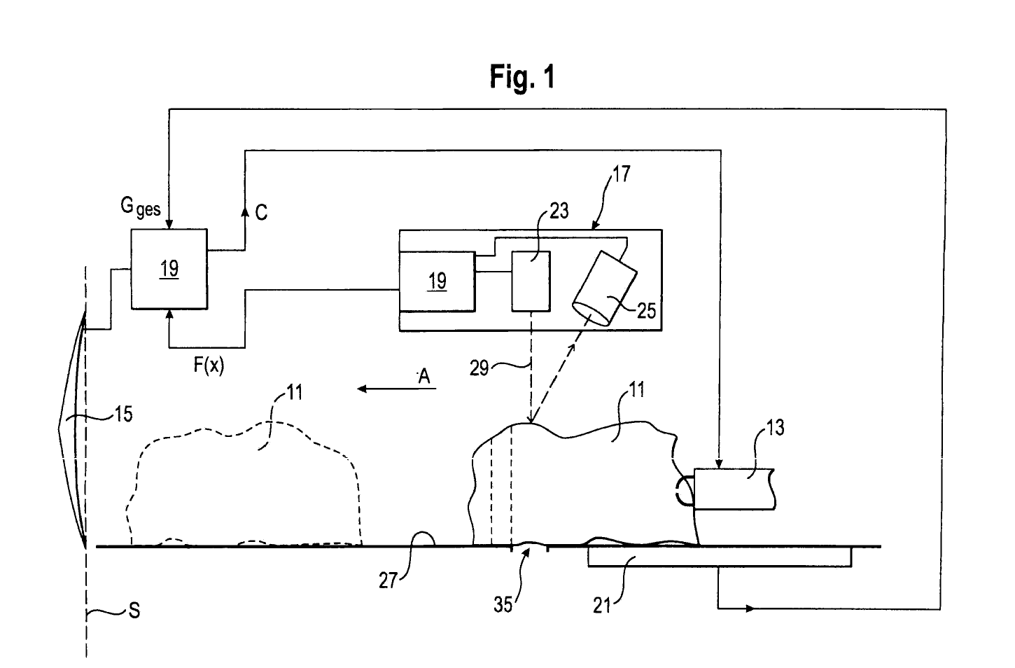

FIG. 1 schematically, a possible embodiment of an apparatus in accordance with the invention;

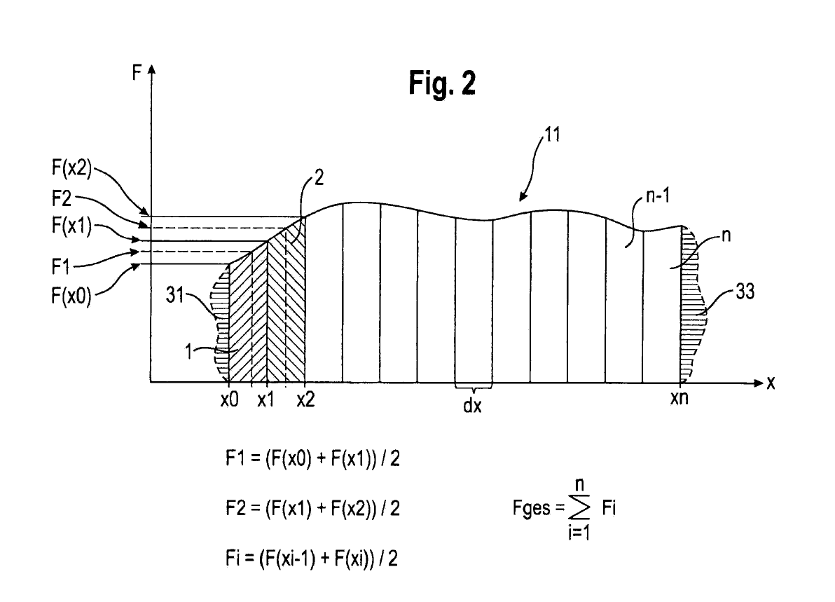

FIG. 2 a representation for explaining the determination of cross-sectional areas of a product to be sliced; and

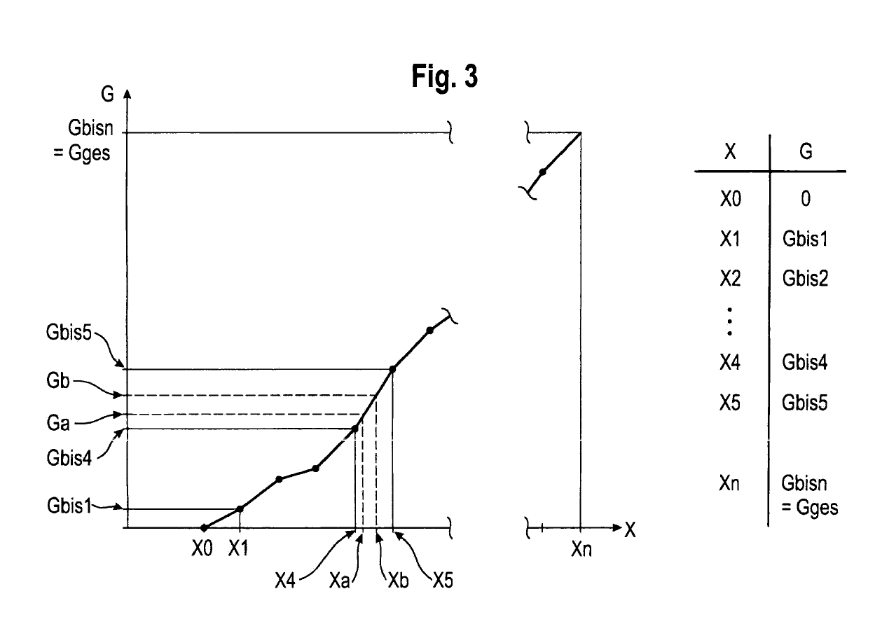

FIG. 3 a representation for explaining a weight table in accordance with the invention.

A possible embodiment of a slicing apparatus in accordance with the invention, simply called a slicer in the following, is shown schematically in FIG. 1 which can be operated in accordance with the method in accordance with the invention.

The slicer includes a product feed 13 which is here provided in the form of a holding device or gripping device which engages at the rear end of the product 11 to be sliced and which is movable by means of a drive, not shown, in a product feed direction A to feed the product 11 to a cutting plane S extending perpendicular to the product feed direction A. In this cutting plane S, a cutting blade 15 moves which can be—as already initially mentioned—a planetary revolving and rotating circular blade, for example, or a scythe-like blade only carrying out a rotation. The products 11 to be sliced lie on a product support 27 which extends parallel to the product feed direction A. Further drive devices for the products 11 which are not shown here can be provided in addition to the product holder 13.

A scanning device 17, which is only shown schematically here and which will also simply be called a scanner in the following, is arranged at a sufficient spacing in front of the cutting plane S. The scanner 17 serves to determine a plurality of cross-sectional areas of a product 11 to be sliced and running through the scanner 17 before the slicing in a scanning plane 29 which in this embodiment is fixed with respect to the cutting plane S and which likewise extends perpendicular to the product feed direction A. An already scanned product at which the slicing has, however, not yet started is shown only for illustration by dashed lines in FIG. 1.

In the embodiment shown here, the scanner 17 works in accordance with the light sectioning process and is for this purpose provided with one or more light sources, for example so-called line lasers, as well as one or more cameras 25.

Only a scanning unit 11 arranged above the product 11 is shown in FIG. 1. The scanner 17 can additionally have a scanning unit arranged beneath the product 11, with suitable means being provided to enable a scanning of the lower side of the product 11, for example, a gap provided at the scanning plane 2) between two mutually following continuous conveyor belts forming the product support 27 at least in the region of the scanning plane 29.

The scanner 17 can generally have any desired number of scanning units arranged in the scanning plane 29 around the product 11 to scan the product 11 “all around” and thus to be able to determine the respective cross-sectional areas with high accuracy.

The generally known light sectioning process is based on the principle of projecting a light line onto the respective surface to be examined—here the surface of the products 11 to be sliced—and of detecting this light line using a suitable detection device. On the basis of the known geometrical relationships, the contour of the surface along the light line can be determined by processing images taken with the detection device. If the surface contour has been determined in a plane around the total object in this manner, the cross-sectional area of the object in this plane can be calculated by means of the light sectioning process, for example. Since light sectioning processes are in particular also known from the already initially named prior art in connection with the slicing of food products, this will not be looked at in any more detail here.

The slicer additionally includes in accordance with the embodiment of FIG. 1 a control and calculation device 19 which here includes two units of which one is arranged in the scanner 17 and the other at a different point, in particular in a controller provided for operating the slicer and in particular the product feed 13. These two units can alternatively also be combined to a single unit. In the embodiment shown, the cross-sectional areas F(x) measured directly at the product 11 are fed to the slicer unit 19 which additionally receives the total weight Gges of the product 11 which is measured by means of scales 21. The scales 21 can be a component of the scanner 17, but can generally also be arranged at another point of the slicer or before the slicer.

The measured cross-sectional areas F(x) transmitted to the slicer unit 19 represent a set of cross-sectional areas which are measured at constant intervals along the product feed direction A at the product 11. This can be achieved, for example, in that the product 1 is moved through the scanner 17 at a constant speed and the scanner 17 is operated at a constant taking frequency. The constant spacing dx between two cross-sectional areas F(x) measured directly following one another amounts, for example, to 5 mm. This constant interval, which is also called a scan width or step size, can be varied by varying the product feed speed and/or the scanning frequency of the scanner 17 in order in this manner to change the accuracy or resolution with which the product 11 is scanned and is measured with respect to its outer surface contour or its profile.

In a manner in accordance with the invention which will be looked at in more detail in the following, the control and calculation unit 19 calculates control data C from the cross-sectional areas of the product 11 and its total weight Gges in order in this manner to vary the slice thickness and thus the slice weight in the respective desired manner on the slicing of the product 11 in the initially explained manner, in particular with the goal of cutting slices of constant weight or slice portions of constant weight from the product 11.

The calculation of the control data C can take place completely or partly in one of the two calculation units 19, i.e. fully or partly either in the scanner 17 or fully or partly at the slicer, i.e. e.g. in the slicer control. This is at the discretion of the user.

The manner of use in accordance with the invention of the cross-sectional areas of the product and of the total product weight for determining the control data C, in particular for preparing a weight table, with which work can then be carried out on the slicing or for preparing a slicing plan, will be explained in the following with reference to FIGS. 2 and 3.

FIG. 2 shows a schematic side view of a food product 11 to be sliced which has already been completely scanned, e.g. by means of a scanner 17 explained with reference to FIG. 1. n cross-sectional areas F(xi) were determined at constant intervals dx along the product fed direction A. In this respect and in the following i=1 to n always applies.

A front product end 31 and a rear product remainder 33, which are indicated by a dashed line in FIG. 2, are not taken into account in this respect. The front product end 31 represents a section not used in practice, whereas the rear product remainder 33 is likewise not used and in particular serves to enable the engagement of a product holder (cf. FIG. 1).

In a preferred embodiment of the invention, the preparation of the weight table does not take place directly with the cross-sectional areas F(xi) measured directly at the product 11, but rather with mean values Fi to which the respective relationship given in FIG. 2 applies. That piece of the product 11 which is disposed exactly between two cross-sectional areas measured following one another will be called a segment in the following. The product 11 in this respect therefore includes n segments. The mentioned mean values of the measured cross-sectional areas, which are also called mean cross-sectional areas or simply cross-sectional areas in the following, consequently each lie within the respective product segment. The mean cross-sectional areas Fi are drawn in FIG. 2 for both first segments of the product 11. Each mean cross-sectional area Fi represents that cross-sectional area which is used for the respective segment in the further calculation.

An area sum Fges is first determined from the mean cross-sectional areas Fi in that all n mean cross-sectional areas Fi are added together in accordance with the relationship shown in FIG. 2.

In accordance with the invention, a weight table is prepared, with reference being made to FIG. 3 for its explanation, from the total product weight Gges, from the mean cross-sectional areas Fi and from the area sum Fges, which is also called a mean area sum since it is formed by adding the mean cross-sectional areas Fi.

The left hand part of FIG. 3 illustrate a weight curve of a product to be sliced in which the points represent values which were actually determined by measurement and which particularly form the elements of the mentioned weight table which is shown in the right hand part of FIG. 3.

This weight table represents the successive, segment-wise adding up of the weights Gi of the individual segments i. At the measurement point x4, for example, that is at the end of the fourth segment, the weight of the product 11 swept over by the scanner 17 up to that time, i.e. passed through the scanning plane 29 (cf. FIG. 1), is the sum from the weight G1 of the first segment, of the weight G2 of the second segment, of the weight G3 of the third segment and of the weight G4 of the fourth segment. This sum is called Gbis4 here. The relation therefore generally applies:

Gbis(i)=Gbis(i−1)+Gi. (1)

At the end of the product 11, that is after the complete scanning of the product 11 and thus at the end of the nth segment, the value Gbisn is in the weight table, i.e. all weights Gi of the n segments were added together. The value Gbisn thus corresponds to the total weight Gges of the product 11.

In accordance with equation (1), the weight table is therefore prepared by successive adding of the segment weights Gi. These segment weights Gi are calculated from the cross-sectional areas Fi, from the mean area sum Fges and from the total product weight Gges in accordance with the following approach in accordance with the invention:

$$Gi = Gges \cdot \frac{Fi}{Fges} . \qquad ( 2 )$$

The approach in accordance with equation (2) is based on the recognition that the weight Gi of a segment of the product behaves in the same way with respect to the total weight Gges of the product as the mean cross-sectional area Fi of the respective segment to the mean area sum Fges. This approach in accordance with equation (2) can be derived under the assumptions that the density D of the product 11 is constant and that the step size dx between two cross-sectional areas F(x) measured following one another is a constant.

If the density D is assumed as constant, the density D can then be calculated both from the total weight Gges of the product and from its total volume Vges and from the weight Gi of any piece of the product having the volume Vi. This arbitrary product piece can, for example, be one of the segments i, that is that product piece which lies between two cross-sectional areas F(x) of the product measured following one another.

The following equation can thus be constructed:

$$\frac{Gges}{Vges} = \frac{Gi}{Vi} . \qquad ( 3 )$$

If, as assumed here, the step size dx is constant, Vi=dx*Fi then applies to each segment volume, on the one hand, and Vges=dx*Fges moreover applies to the total volume Vges of the product. If these two equations are used for the segment volume Vi and for the total volume of the product Vges in the above equation (3) and if the resulting equation is transposed, the above equation (2) results, i.e. the approach for the segment weights Gi used for preparing the weight table.

The above statements are only intended to show the requirements under which the approach in accordance with equation (2) is correct. In actual fact, neither a volume calculation nor a density calculation takes place in the invention since equation (2) only contains surface values and the total product weight.

As already explained above, work can be carried out with the weight table prepared in this manner during the slicing or within the framework of the preparation of a slicing plan.

It must again be pointed out in this respect that the weight table only contains discrete weight values for part sums of the segment weights Gi. The part sums are—as mentioned—illustrated by the dots in the left hand representation of FIG. 3. If these points, that is the individual part sums, are each connected by a straight line, the weight curve of the respective product shown in the left hand representation of FIG. 3 is obtained. The sought values for the layer thickness which respectively have to be realized by means of the product feed to obtain a specific slice weight, are obtained by interpolation between the discrete values of the weight table. This will be explained in the following, and indeed likewise with respect to the left hand representation of FIG. 3.

If, for example, the cutting blade is located at the point xa in the fifth segment after the cutting off of a product slice during the cutting process, that is between the fourth measured cross-sectional area F(x4) and the fifth measured cross-sectional area F(x5) and if the next product slice to be cut off should have a weight e.g. of 20 g on the basis of an external specification, the question therefore has to be asked how far the product 11 has to be advanced next so that the product slice subsequently cut off from the product 11 at the point xb has a weight of 20 g. The sought variable, namely the required layer thickness and thus the required adjustment path for the product 11 to be effected by the product feed can be derived from the weight curve in a simple manner. This was done purely schematically in a graphic manner in the left hand representation of FIG. 3. The control and calculation unit 19 (cf. FIG. 1), in contrast, carries out corresponding calculation operations on the basis of the values present in the form of the weight table.

The cutting blade in the above example is therefore at the point xa in the product which corresponds to an accumulated product weight of Ga, and what is sought is consequently that position xb with which an accumulated product weight Gb=Ga+20 g corresponds. The following equation (4) indicates how xb results by interpolation between the points x4 and x5 of the weight table. In this respect Gbis5−Gbis4 is the weight of the respective segment whose thickness corresponds to the constant step size dx. Gb−Ga furthermore designates the predefined desired weight of the slice to be cut off (in this example 20 g) whose thickness is xb−xa. This rule of three relationship resolved according to xb produces the following equation (4)

$$xb = xa + dx \cdot \frac{Gb - Ga}{Gbis 5 - Gbis 4} . \qquad ( 4 )$$

In accordance with the invention, consequently the explained weight table is only prepared from the cross-sectional areas Fi and from the total weight Gges of the product and work is carried out in the above-explained manner using said weight table during the slicing or within the framework of the preparation of a slicing plan. A calculation of variables which are not required such as the product volume or the average product density is not provided in accordance with the invention.

### REFERENCE NUMERAL LIST

11 product
13 product feed
15 cutting blade
17 scanning device
19 control and calculation device
21 scales
23 light source, line laser
25 detection device, camera
27 product support
29 scanning plane
31 front product end
33 rear product end
35 gap
A product feed direction
C control data
F(x) measured cross-sectional areas
Fi cross-sectional areas
Fges area sum
Gges total product weight
dx interval

1-16. (canceled)

17. A method for acquiring slices or portions of slices of constant weight from food products sliced by a cutting apparatus, comprising:
providing at least one product to be sliced;
determining a plurality of cross-sectional areas Fi of the product;
determining the total weight Gges of the product;
calculating control data using the cross-sectional areas Fi and the total weight Gges;
operating the cutting apparatus at least in part using the control data; and
preparing a weight table Gbis(i) for the calculation of the control data only from the cross-sectional areas Fi and from the total weight Gges in accordance with
Gbis(i)=Gbis(i−1)+Gi,
wherein Gi=Gges*Fi/Fges and i=1 to n.

18. A method in accordance with claim 17, further comprising providing a product feed of the cutting apparatus for supplying the product along a product feed direction to a cutting plane in which at least one cutting blade moves, with the product feed direction extending perpendicular to the cutting plane.

19. A method in accordance with claim 17, wherein the cross-sectional areas Fi are determined perpendicular to a product feed direction.

20. A method in accordance with claim 17, wherein the cross-sectional areas Fi are determined at constant intervals dx along the product feed direction.

21. A method in accordance with claim 17, including calculating the cross-sectional surfaces Fi as a mean value of two cross-sectional areas (fx) measured directly following one another.

22. A method in accordance with claim 17, wherein an interpolation is carried out between mutually following values of the weight table Gbis(i) for calculating the control data.

23. A method in accordance with claim 17, wherein the weight table Gbis(i) is prepared before the start of the slicing of the product.

24. A method in accordance with claim 17, including calculating control data during the slicing.

25. A method in accordance with claim 17, wherein a slicing plan is prepared before the start of slicing of the product using the weight table Gbis(i).

26. A method in accordance with claim 17, including determining the plurality of cross-sectional areas Fi of the product by a light sectioning process.

27. A method in accordance with claim 17, including operating a product feed of the cutting apparatus using the control data.

28. A method in accordance with claim 17, wherein the cutting apparatus comprises a blade operated in one of a rotating manner and a planetary revolving manner.

29. A method in accordance with claim 17, wherein a high performance slicer is used as the cutting apparatus.

30. A method for determining control data for an apparatus for slicing food products, comprising:
determining a plurality of cross-sectional areas Fi of at least one product to be sliced; and
preparing a weight table Gbis(i) only from the cross-sectional areas Fi and from the total weight Gges of the at least one product for determining the control data in accordance with
Gbis(i)=Gbis(i−1)+Gi,
wherein Gi=Gges*Fi/Fges and i=1 to n.

31. An apparatus for slicing food products, comprising:
a product feed which is designed to feed at least one product to be sliced to a cutting plane in which at least one cutting blade moves;
a scanning device, working in accordance with a light sectioning process, for determining a plurality of cross-sectional areas Fi of the product; and
a control and calculation device for calculating a control data using the cross-sectional areas Fi and the total weight Gges of the product and for operating the cutting apparatus, while using the control data, and the control and calculation device is designed to prepare a weight table Gbis(i) only from the cross-sectional areas Fi and from the total weight Gges for the calculation of the control data in accordance with
Gbis(i)=Gbis(i−1)+Gi,
wherein Gi=Gges*Fi/Fges and i=1 to n.

32. An apparatus in accordance with claim 31, in which said cutting apparatus is a high performance slicer.

33. Apparatus in accordance with claim 31, wherein said cutting apparatus includes a blade and a drive means for driving the blade in one of a rotating manner and a planetary revolving manner.

34. An apparatus in accordance with claim 31, wherein said control and calculation device for calculating the control data using the cross-sectional areas Fi and the total weight Gges of the product is adapted to operating the product feed of the cutting apparatus.

35. An apparatus in accordance with claim 31, wherein scales are provided for measuring the total weight Gges of the product.

36. An apparatus for determining a control data for an apparatus for slicing food products, comprising:
a scanning device for determining a plurality of cross-sectional areas Fi of at least one product to be sliced; and
a calculation device which is designed to prepare a weight table Gbis(i) only from the cross-sectional areas Fi and from the total weight Gges of the product for calculating the control data in accordance with
Gbis(i)=Gbis(i−1)+Gi,
wherein Gi=Gges*Fi/Fges and i=1 to n.

37. An apparatus in accordance with claim 36, including scales for measuring the total weight Gges of the product.
